(19) United States
(12) Patent Application Publication
(10) Pub. No.: US 2015/0293640 A1
(43) Pub. Date: Oct. 15, 2015

(54) OPERATION DEVICE

(71) Applicants: KABUSHIKI KAISHA TOKAI RIKA DENKI SEISAKUSHO, Aichi (JP); The University of Tokyo, Tokyo (JP)

(72) Inventors: Shuichi TAKEUCHI, Aichi (JP); Ken SASAKI, Tokyo (JP); Kazuki TERADA, Tokyo (JP); Shohei MISHIMA, Tokyo (JP)

(21) Appl. No.: 14/632,642

(22) Filed: Feb. 26, 2015

(30) Foreign Application Priority Data
Apr. 9, 2014 (JP) 2014-079947

(51) Int. Cl. G06F 3/041; G06F 3/01

(52) U.S. Cl. CPC G06F 3/0416; G06F 3/017

(57) ABSTRACT

An operation device includes a detection part configured to detect an operation applied to an operation surface so as to calculate a detection point on the operation surface, a target position setting part configured to set a target position on the operation surface based on information retrieved from an operated object, a distance of overshoot setting part configured to set a distance of overshoot based on the target position set, the distance of overshoot being predicted a distance to be overshot by the detection point from the target position while the detection point moves, a notification region setting part configured to set a notification region configured to perform notification based on the target position and the distance of overshoot, and a notification part configured to notify that the detection point has reached the notification region.

The present application is based on Japanese patent application No. 2014-079947 filed on Apr. 9, 2014, the entire contents of which are incorporated herein by reference.

### BACKGROUND OF THE INVENTION

1. Field of the Invention

This invention relates to an operation device.

2. Description of the Related Art

A tactile presentation device is known which has a display panel configured to display image information, a touch panel formed on the display panel, the touch panel being configured to detect a position coordinate touched with an operation finger, a first oscillation actuator configured to oscillate the touch panel in a direction of the X axis, a second oscillation actuator configured to oscillate the touch panel in a direction of the Y axis, and a control part configured to drive the first oscillation actuator and the second oscillation actuator if the operation finger is moved while touching the touch panel in a region of the display panel where a predetermined image information is displayed (e.g., refer to JP-A-2013-97438).

The tactile presentation device is configured to drive the first oscillation actuator and the second oscillation actuator when the operation finger is detected in the region (i.e., region corresponding to the predetermined image information on the display panel) of the touch panel. Thus, the operator stimulated by the oscillation can easily sense the position of the predetermined image information displayed on the display panel without looking at the display panel.

### SUMMARY OF THE INVENTION

The tactile presentation device disclosed in JP-A-2013-97438 is configured so as not to drive the first oscillation actuator and the second oscillation actuator before the operation finger is detected in the region (or target region) corresponding to the predetermined image information on the display panel. Thus, time elapses until the operator senses the stimulation from the touch panel and then stops swiping the operation finger. Therefore, the stop position of the operation finger may overshoot the region (or target region) so as to force the operator to try again the swipe operation to reach the region.

It is an object of the invention to provide an operation device that prevents the operation finger from overshooting the target position (or target region).

(1) According to one embodiment of the invention, an operation device comprises:

a detection part configured to detect an operation applied to an operation surface so as to calculate a detection point on the operation surface;

a target position setting part configured to set a target position on the operation surface based on information retrieved from an operated object;

a distance of overshoot setting part configured to set a distance of overshoot based on the target position set, the distance of overshoot being predicted a distance to be overshot by the detection point from the target position while the detection point moves;

a notification region setting part configured to set a notification region configured to perform notification based on the target position and the distance of overshoot; and

a notification part configured to notify that the detection point has reached the notification region.

### Effects of the Invention

According to one embodiment of the invention, an operation device that prevents the operation finger from overshooting the target position (or target region).

### BRIEF DESCRIPTION OF THE DRAWINGS

The preferred embodiments according to the invention will be explained below referring to the drawings, wherein:

FIG. 1A is a perspective view schematically showing an inside of a vehicle in which an operation device according to an embodiment is mounted;

FIG. 1B is an illustration diagram schematically showing a display screen of a display device;

FIG. 1C is an illustration diagram schematically showing a touch sensor;

FIG. 2A is a block diagram of the operation device according to the embodiment;

FIG. 2B is a block diagram of a vehicle communication system to which the operation device is connected;

FIG. 3A is a graph schematically showing a first oscillation pattern that an oscillation presentation part of the operation device according to the embodiment presents;

FIG. 3B is a graph schematically showing a second oscillation pattern that the oscillation presentation part presents;

FIG. 4A is an illustration diagram schematically showing an experimental device used for an experiment with regard to a distance of overshoot;

FIG. 4B is a block diagram of the experimental device;

FIG. 5A is a graph showing a movement of the operation finger on the operation surface;

FIG. 5B is a graph showing a relationship between the speed of the operation finger and the distance of overshoot in case of presenting oscillation at the target position;

FIG. 5C is a graph showing a relationship between the speed of the operation finger and the distance of overshoot in case of presenting oscillation after correcting the distance of overshoot estimated; and

FIG. 6 is a flowchart for explaining an operation of the operation device according to the embodiment.

### DETAILED DESCRIPTION OF THE PREFERRED EMBODIMENTS

### Summary of Embodiment

The operation device according to the embodiment roughly includes a detection part configured to detect an operation applied to an operation surface so as to calculate a detection point on the operation surface, a target position setting part configured to set a target position on the operation surface based on information retrieved from an operated object, a distance of overshoot setting part configured to set a distance of overshoot based on the target position set, the distance of overshoot being predicted a distance to be overshot by the detection point from the target position while the detection point moves, a notification region setting part configured to set a notification region configured to perform notification based on the target position and the distance of overshoot and a notification part configured to notify that the detection point has reached the notification region.

The operation device is configured to set the notification region based on the distance of overshoot, thus, in comparison with a case that the notification region based on the distance of overshoot is not set, even if the operation finger is moved until the operator becomes aware of the notification so as to stop the operation, it becomes possible to stop the operation finger at the target position, so that the operation device is capable of notifying to prevent an operation of overshoot that the operation finger passes through the target position.

(Whole Configuration of Operation Device 1)

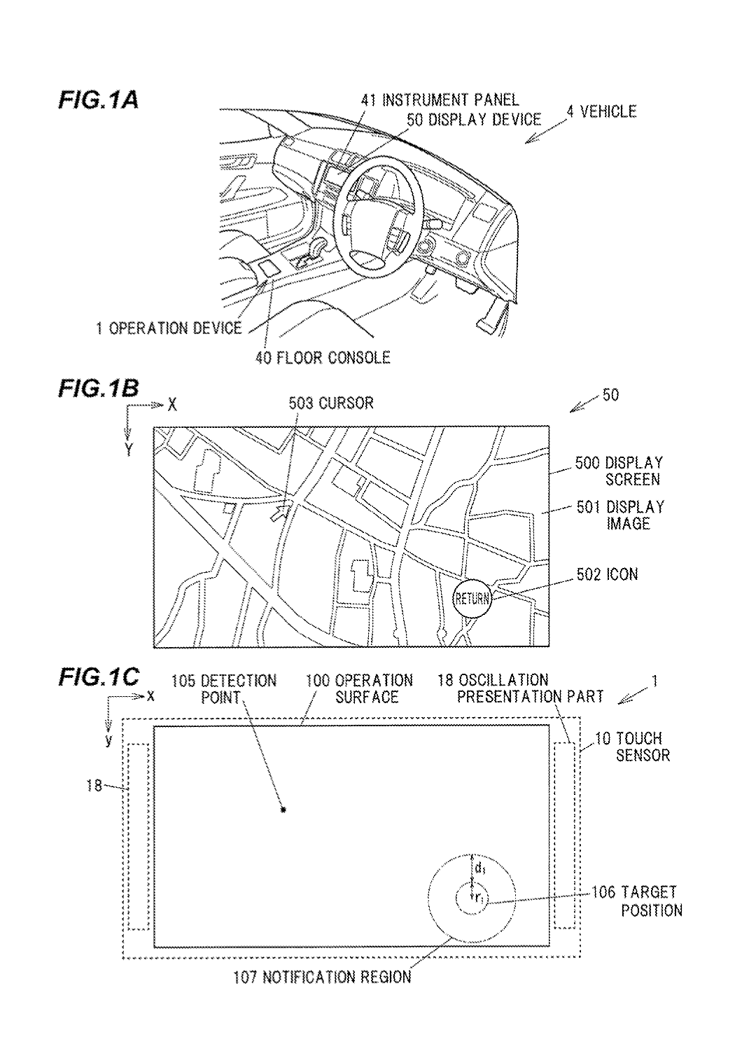

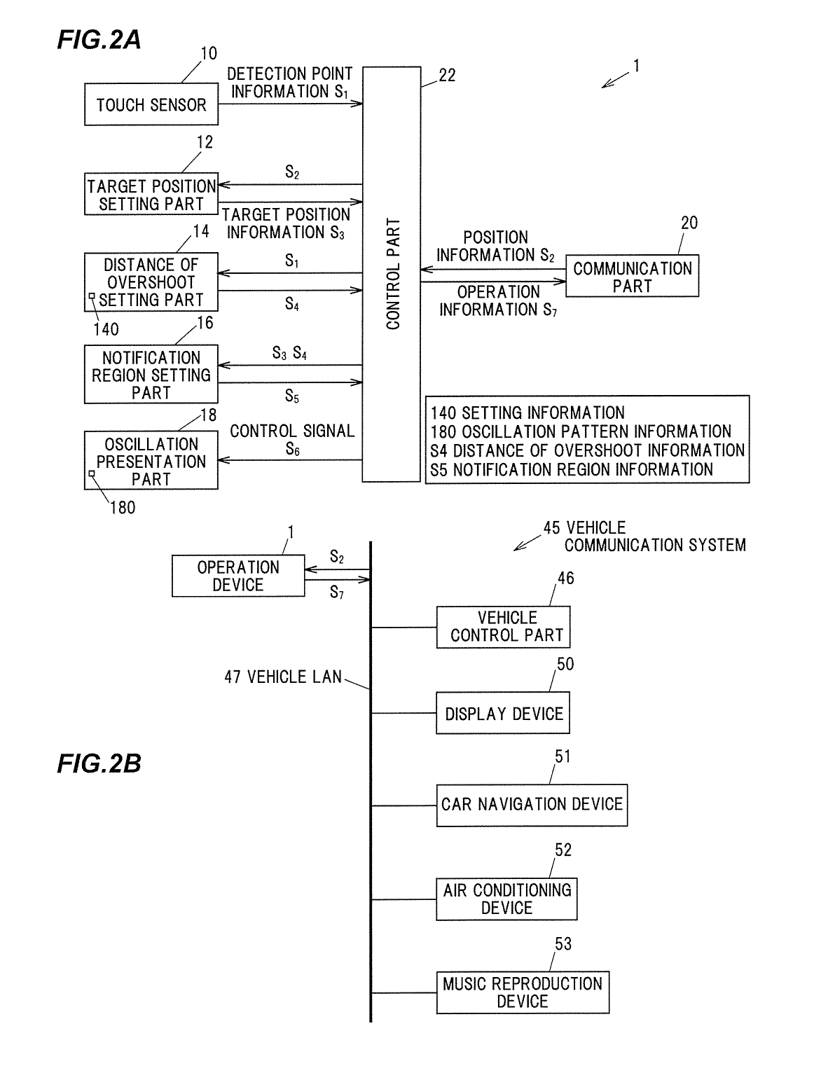

FIG. 1A is a perspective view schematically showing an inside of a vehicle in which an operation device according to an embodiment is mounted, FIG. 1B is an illustration diagram schematically showing a display screen of a display device and FIG. 1C is an illustration diagram schematically showing a touch sensor. FIG. 2A is a block diagram of the operation device according to the embodiment and FIG. 2B is a block diagram of a vehicle communication system to which the operation device is connected. FIG. 1C shows the detection point 105 that is a point at which a swipe operation is first detected due to the fact that an operator has performed the swipe operation from a slightly remote position for the purpose of applying an operation to “RETURN” icon 502 shown in FIG. 1B. Further, in each drawing described below according to the embodiment, the ratio between figures may be different from the actual ratio. In addition, in FIG. 2A and FIG. 2B, a flow of main signals and information is shown by an arrow. Herein, the swipe operation is defined as the operation that a detected object such as an operation finger and a stylus pen is allowed to move on the operation surface while contacting the operation surface. The detection point moves on the detection surface by the swipe operation.

As shown in FIG. 1A, the operation device 1 is arranged in a floor console 40 of a vehicle 4. In addition, the operation device 1 is configured to, for example, be able to perform an operation of an electronic equipment (or a display device 50) as an operated object electromagnetically connected thereto. Furthermore, the operation device 1 is configured to, for example, be able to carry out an instruction such as movement and selection of a cursor displayed on the electronic equipment, selection, decision, drug, drop of an icon displayed, dependent on an operation performed. Further, the electromagnetic connection means a connection that uses at least one of a connection by a conductor, a connection by a light that is a kind of an electromagnetic wave, and a connection by an electric wave that is a kind of an electromagnetic wave.

As shown in FIG. 1C and FIG. 2A, the operation device 1 roughly includes a touch sensor 10 as a detection part configured to detect an operation applied to an operation surface 100 so as to calculate a detection point on the operation surface 100, a target position setting part 12 configured to set a target position 106 on the operation surface 100 based on a position information S₂ as information retrieved from an operated object, a distance of overshoot setting part 14 configured to set a distance of overshoot based on the target position 106 set, the distance of overshoot being a distance by which the detection point moves while overshooting the target position 106, a notification region setting part 16 configured to set a notification region 107 configured to perform notification based on the target position 106 and the distance of overshoot and an oscillation presentation part 18 as a notification part configured to notify that the detection point has reached the notification region 107.

In addition, as shown in FIG. 2A, the operation device 1 includes a communication part 20 and a control part 22. As shown in FIG. 2B, the operation device 1 is electrically connected to a vehicle communication system 45 via the communication part 20.

(Configuration of Touch Sensor 10)

The touch sensor 10 is, for example, a sensor configured such that a part (e.g., operation finger) of the body of the operator or a dedicated pen touches the operation surface 100, thereby a position on the operation surface 100 touched is detected. The operator, for example, applies an operation to the operation surface 100, thereby it becomes possible for the operator to perform an operation of an electronic equipment connected. As the touch sensor 10, for example, a well-known sensor such as a resistive film system sensor, an infrared ray system sensor, a SAW (Surface Acoustic Wave) system sensor, an electrostatic capacity system sensor can be used. Further, the touch sensor 10 is configured to calculate a detection point that is a position on the operation surface 100 at which the operation finger of the operator is detected. The touch sensor 10 is configured to, as one example, obtain a weighted average based on retrieved electrostatic capacity so as to calculate the detection point.

The touch sensor 10 is, for example, a touch panel of an electrostatic capacity system configured to detect a change of electric current inversely proportional to a distance between a sensor wire and the operation finger due to an approach of the operation finger to the operation surface 100. A plurality of sensor wires (not shown) are disposed under the operation surface 100.

The touch sensor 10 is configured to output information of the detection point of one cycle as a detection point information S₁ to the control part 22, the one cycle being defined as a period for scanning all of a plurality of the sensor wires. The detection point information S₁ includes, as one example, if the detection point is detected, information of the coordinate thereof, and if the detection point is not detected, information showing the fact of no detection.

The touch sensor 10 constitutes, for example, an absolute coordinate system that the shown in FIG. 2B and the operation surface 100 perform one-to-one correspondence.

As shown in FIG. 1C, the touch sensor 10 has a rectangular shape, and a region operably exposed constitutes the operation surface 100. Consequently, the touch sensor 10 is configured to defect an operation applied to the operation surface 100.

The operation surface 100 is configured such that, for example, the origin is located at the top left corner of FIG. 1C, and simultaneously the Y axis is located in the vertical direction (top to bottom) and the X axis is located in the horizontal direction (left to right). In addition, the display screen 500 described below of the display device 50 is configured such that, for example, the origin is located at the top left corner of FIG. 1B, and simultaneously the Y axis is located in the vertical direction (top to bottom) and the X axis is located in the horizontal direction (left to right). Accordingly, the operation surface 100 and the display screen 500 have a similar shape to each other.

Further, in the embodiment, the setting of the notification region in consideration with the distance of overshoot is carried out in the absolute coordinate system, but not particularly limited to this, the setting may be carried out in a relative coordinate system. In case of the relative coordinate system, the operation device 1 is configured to, as one example, calculate a distance from the position of the cursor 503 on the display screen 500, the cursor 503 being corresponding to the detection point 105 to the icon 502 that is the operation target, so as to calculate the target position 106 based on the distance calculated. The operation device 1 is configured to set the notification region 107 if the target position 106 calculated is located on the operation surface 100.

(Configuration of Target Position Setting Part 12)

The target position setting part 12 is configured to set the target position 106 based on the position information S₂ retrieved via the communication part 20. The position information S₂ includes, as one example, as shown in FIG. 1B, being selectable in the display image 501 displayed in the display screen 500, and is retrieved from the electronic equipment as the operated object. Further, a plurality of the target positions may be adopted.

For example, if the icon 502 displayed by a word of “RETURN” shown in FIG. 1B is the above-mentioned selectable icon, the position information S₂ includes the position information of the icon 502 in the display screen 500. The position information is, for example, a coordinate of XY coordinate system that is a coordinate system of the display screen 500.

The target position setting part 12 is configured to convert the coordinate in the XY coordinate system of the icon 502 included in the position information S₂ to the coordinate in the XY coordinate system of the operation surface 100, and simultaneously to generate a target position information S₃ including information of the coordinate converted so as to output to the control part 22. The coordinate in the XY coordinate system is the target position 106 shown in FIG. 1C. Further, the icon 502 is not a point but has a spread, thus the target position 106 has also a spread. If the position information S₂ has information of a point, the target position setting part 12 is configured to set the target position 106 of a point. In addition, the shape of the target position 106 is not particularly limited to a similar shape to an image that is an object of the target position 106 as shown in FIG. 1C, but any shape may be used.

(Configuration of Distance of Overshoot Setting Part 14)

The distance of overshoot setting part 14 is configured to predict the distance of overshoot so as to set it based on the detection point information S₁ and a setting information 140 predetermined.

The distance of overshoot means a distance by which the operation finger is predicted to overshoot the target position while moving until the operator stops the operation finger, if the operation finger has reached the target position and then presents oscillation. The setting information 140 is set, for example, based on knowledge retrieved from a result of the experiment described below. Accordingly, the distance of overshoot is described below.

The distance of overshoot setting part 14 is configured to generate a distance of overshoot information S₄ based on the distance of overshoot set so as to output to the notification region setting part 16 via the control part 22.

(Configuration of Notification Region Setting Part 16)

The notification region setting part 16 is configured to set the notification region 107 based on the target position information S₃ and the distance of overshoot information S₄.

For example, the notification region setting part 16 is configured to set the notification region 107 as follows. Namely, as shown in FIG. 1C, the target position (or target region) 106 obtained based on the target position information S₃ is a circle having a radius of r₁ and the distance of overshoot obtained based on the distance of overshoot information S₄ is d₁. Then, the region that is inside a circle having a radius of (r₁+d₁) and centering at the center of the target position 106, and simultaneously is outside the target position 106 is set as the notification region 107.

The notification region 107 may have a shape other than a circle. As one example, if the target position 106 has a shape other than a circle, the notification region 107 is set as a region in which the target position 106 is included and a distance between the target position 106 and the notification region 107 becomes the distance of overshoot (d₁).

(Configuration of Oscillation Presentation Part 18)

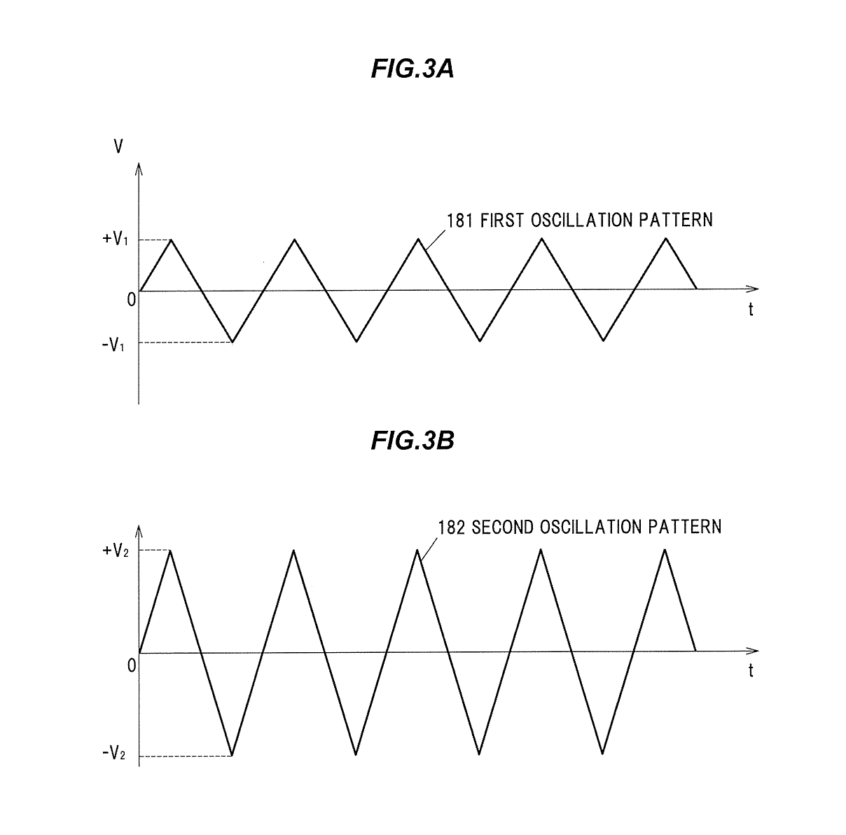

FIG. 3A is a graph schematically showing a first oscillation pattern that an oscillation presentation part of the operation device according to the embodiment presents, and FIG. 3B is a graph schematically showing a second oscillation pattern that the oscillation presentation part presents. FIG. 3A and FIG. 3B are configured such that the vertical axis shows a voltage (V) and the horizontal axis shows a time (t).

As shown in FIG. 1C, the oscillation presentation part 18 is arranged in a rear surface side of the operation surface 100 of the touch sensor 10. The oscillation presentation part 18 is configured to oscillate the operation surface 100 in the horizontal direction.

The oscillation presentation part 18 is, as one example, a monomorph-type piezoelectric actuator including a metal plate and a piezoelectric element. Further, a modification of the oscillation presentation part 18 includes a bimorph-type piezoelectric actuator configured such that two piezoelectric elements are disposed on both surfaces of the metal plate.

The piezoelectric element is configured to, for example, carry out telescopic motion due to a voltage supplied thereto. The oscillation presentation part 18 is configured to bend the metal plate due to the telescopic motion of the piezoelectric element, and to generate oscillation due to the bending of the metal plate.

As materials of the piezoelectric element, for example, lithium niobate, barium titanate, lead titanate, lead zirconate titanate (PZT), lead metaniobate, polyvinylidene fluoride (PVDF) and the like are used. The piezoelectric element is, for example, a laminated piezoelectric element formed by laminating films comprised of the above-mentioned materials.

In the embodiment, as shown in FIG. 1C, two piezoelectric actuators are arranged on both ends of the rear surface of the operation surface 100.

The oscillation presentation part 18 has an oscillation pattern information 180 and is configured to present oscillation in accordance with the oscillation pattern information 180 and a control signal S₆ retrieved.

The oscillation presentation part 18 is configured to carry out a first notification when the detection point is detected in the notification region, and to carry out a second notification different from the first notification when the detection point is detected in the target position. The first notification is, for example, an oscillation based on the first oscillation pattern 181 shown in FIG. 3A. In addition, the second notification is, for example, an oscillation based on the second oscillation pattern 182 shown in FIG. 3B.

The first oscillation pattern 181 is, as one example, an oscillation pattern having the amplitude of V₁. The second oscillation pattern 182 is, as one example, an oscillation pattern having the amplitude of V₂ that is twice as larger as the amplitude of V₁ of the first oscillation pattern 181, and having the same wavelength. Namely, the second oscillation pattern 182 applies stimulation to the operator more than the first oscillation pattern 181. Further, as a modification, the oscillation presentation part 18 may be configured such that the first oscillation pattern 181 applies stimulation to the operator more than the second oscillation pattern 182.

(Configuration of Communication Part 20)

As shown in FIG. 2A and FIG. 2B, the communication part 20 is configured to be capable of exchanging information and signals with the vehicle control part 46 and the like via the vehicle LAN (Local Area Network) 47. The communication part 20 is configured to output the position information S₂ and simultaneously to retrieve operation information S₇ described below.

The vehicle communication system 45 mainly includes the vehicle control part 46 and the vehicle LAN 47. FIG. 2B shows an aspect that the display device 50 configured to display an image, a car navigation device 51 configured to display the present position and simultaneously to guide a route to the destination, an air conditioning device 52 configured to adjust the temperature in the vehicle 4 and music reproduction device 53 configured to reproduce music are electromagnetically connected to the vehicle communication system 45. The vehicle control part 46 is, for example, a microcomputer configured to control the vehicle LAN 47 and the like.

The display device 50 functions, for example, as a display part of an electronic equipment as the operated object. If the car navigation device 51 is the operated object, for example, as shown in FIG. 1B, a map image is displayed in the display screen 500 of the display device 50 as the display image 501.

(Configuration of Control Part 22)

The control part 22 is, for example, a microcomputer including a CPU (Central Processing Unit) configured to carry out an arithmetic operation, processing and the like to the data retrieved, in accordance with programs stored, a RAM (Random Access Memory) and a ROM (Read Only Memory) that are a semiconductor memory, and so on. The ROM, for example, stores programs for operating the control part 22 therein. The RAM, for example, is used as a storage area for storing information of the detection point temporarily arithmetically operated and so on.

The control part 22 is configured to generate the operation information S₇ based on the detection point information S₁, so as to output to the operated object via the communication part 20. In addition, the control part 22 is configured to generate the control signal S₆ for controlling the oscillation presentation part 18 to present an oscillation dependent on the first oscillation pattern 181 if the detection point is detected in the notification region 107, and controlling the oscillation presentation part 18 to present an oscillation dependent on the second oscillation pattern 182 if the detection point is detected in the target position 106, so as to output to the oscillation presentation part 18. Further, the oscillation presentation may be carried out within a predetermined time.

Hereinafter, an experiment with regard to the distance of overshoot will be explained.

(Experiment with Regard to Distance of Overshoot)

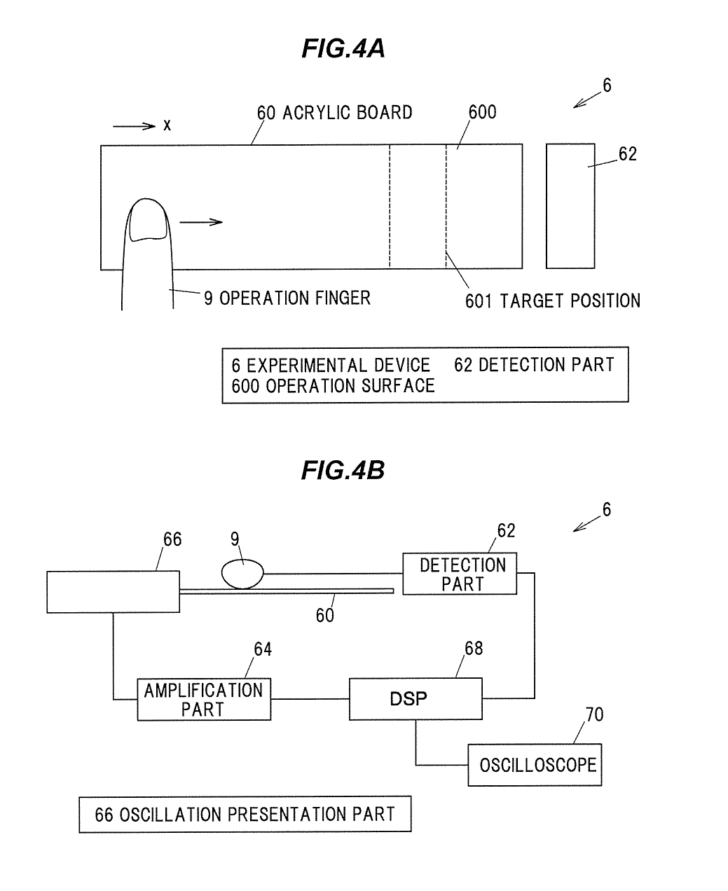

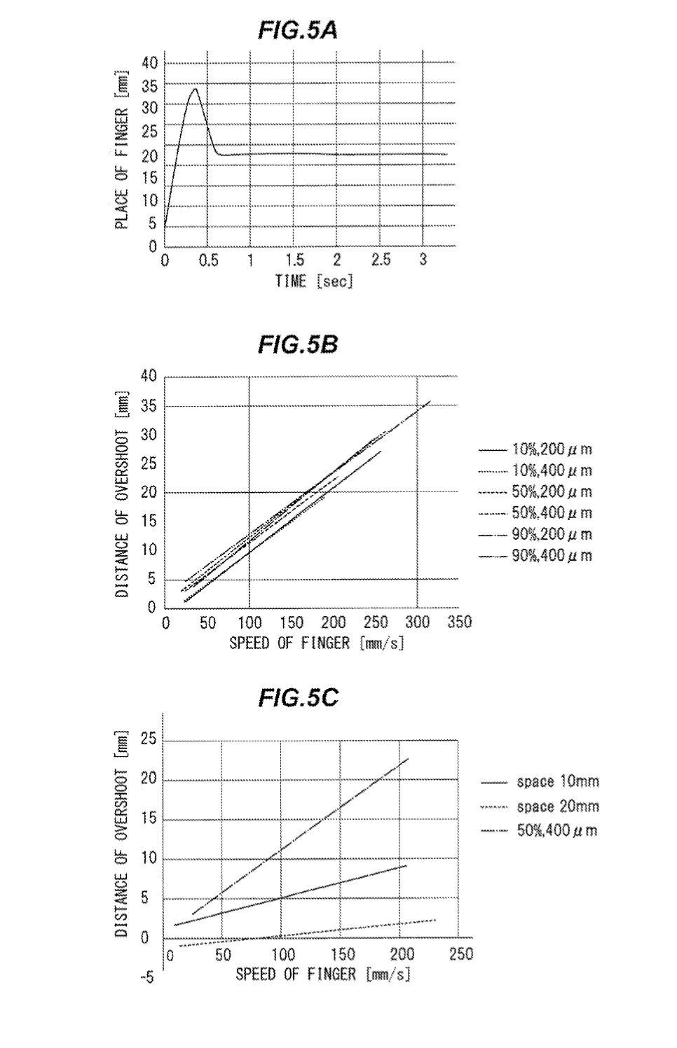

FIG. 4A is an illustration diagram schematically showing an experimental device used for an experiment with regard to a distance of overshoot, and FIG. 4B is a block diagram of the experimental device. FIG. 5A is a graph showing a movement of the operation finger on the operation surface, FIG. 5B is a graph showing a relationship between the speed of the operation finger and the distance of overshoot in case of presenting oscillation at the target position and FIG. 5C is a graph showing a relationship between the speed of the operation finger and the distance of overshoot in case of presenting oscillation after correcting the distance of overshoot estimated. FIG. 5A is configured such that the vertical axis shows a place of finger (mm) and the horizontal axis shows a time (sec). FIG. 5B and FIG. 5C s configured such that the vertical axis shows a distance of overshoot (mm) and the horizontal axis shows a speed of finger (mm/s).

As shown in FIG. 4A and FIG. 4B, the experimental device 6 roughly includes an acrylic board 60, a detection part 62, an amplification part 64, an oscillation presentation part 66, a DSP (Digital Signal Processor) 68 and an oscilloscope 70.

The acrylic board 60 is comprised of an acrylic resin so as to have a plate-like shape. The acrylic board 60 has a length of approximately 15 cm. The detection part 62 is a laser displacement gauge configured to measure a movement distance of the operation finger 9. The amplification part 64 is an amplification circuit configured to amplify a voltage output from the DSP 68 so as to output to the oscillation presentation part 66. The oscillation presentation part 66 is configured to apply an oscillation to the acrylic board 60 based on the voltage input. The DSP 68 is configured to control a voltage for driving the oscillation presentation part 66. The oscilloscope 70 is configured to observe a waveform of the voltage input to the oscillation presentation part 66.

The first experiment was carried out in the following procedure. A subject carries out a swipe operation on the operation surface 600 of the acrylic board 60 from left to right in FIG. 4A, namely in the X direction so as to search the target position 601. The target position 601 is set as a region having a width (or space) of 10 mm. The DSP 68 applies an oscillation to the acrylic board 60 via the oscillation presentation part 66 if the operation finger 9 is located in the target position 601. The target position 601 is randomly changed for each trial by the DSP 68 for the purpose of suppressing habituation of the subject. The oscillation generated by the oscillation presentation part 66 is six kinds of oscillations having a triangular-wave shape, the oscillations being obtained by mutually combining a duty ratio of 10%, 50% and 90%, an amplitude of 200 μm and 400 μm, and a frequency of 40 Hz.

In the first experiment, the subject carries out a plurality of times an action of stopping the operation finger 9 in the target position 601 relying on the above-mentioned oscillation, as a result, as shown in FIG. 5A, behaviors of returning to the target position 601 after one passing through the target position 601 are often observed. Especially, the above-mentioned behaviors are often observed if the speed of the operation finger 9 is faster than 100 mm/s. Thus, subsequently, the second experiment was carried out as follows.

The second experiment was carried out so as to study a relationship between a distance by which the operation finger 9 overshoots the target position 601 while passing through the target position 601 and then returning thereto and a speed of the operation finger 9 at the time of passing through the target position 601.

In the second experiment, the above-mentioned trial was carried out 250 times so as to obtain regression lines shown in FIG. 5B. As shown in FIG. 5B, in the second experiment, it was confirmed that there was a positive correlation between the speed of the operation finger 9 and the distance of overshoot, and simultaneously there was almost no difference due to the oscillation presented.

The correlation coefficient is 0.793 (200 μm, 10%), 0.773 (200 μm, 50%), 0.762 (200 μm, 90%), 0.741 (400 μm, 10%), 0.722 (400 μm, 50%) and 0.722 (400 μm, 90%).

In addition, by the regression lines based on the second experiment, the distance of overshoot becomes 11 mm if the speed of the operation finger 9 is 100 mm/s, thus it is confirmed that the distance of overshoot exceeds 10 mm that is a space (or width) of the target position 601.

Subsequently, based on the above-mentioned result, the third experiment was carried out, the experiment testing whether a correction can effectively guide the operation finger 9 so as not to pass through the target position 601 or not, the correction being based on the distance of overshoot predicted in accordance with the speed while using the relational expression between the speed of the operation finger 9 and the distance of overshoot. The expression of the regression lines is y=0.11x. However, x is the speed (mm/s) of the operation finger 9 and y is the distance of overshoot (mm).

In the third experiment, the DSP 68 successively calculates the distance of overshoot from the above-mentioned expression of the regression lines so as to add to the position coordinate of the operation finger 9, and presents an oscillation of 200 μm after the position coordinate, to which the distance of overshoot is added, of the operation finger 9 reaches the position coordinate of the target position 601, and presents an oscillation of 400 μm when the operation finger 9 reaches within the range of the target position 601. The oscillation is an oscillation having a triangular-wave shape, and having a frequency of 40 Hz and a duty ratio of 50%. The space (or width) of the target position 601 is set to 10 mm and 20 mm.

The third experiment results in a graph as shown in FIG. 5C. The correlation coefficient is 0.793 (space: 10 mm), and 0.741 (space: 20 mm). In FIG. 5C, for comparison, a result if an oscillation having an amplitude of 400 μm is presented is also shown.

As shown in FIG. 5C, the inclination of the regression line, the inclination showing a relationship between the speed of the operation finger and the distance of overshoot, is reduced as the space is increased. Accordingly, it was confirmed that if the speed of the operation finger is high, by carrying out a correction, the distance of overshoot is reduced, thus it becomes possible to effectively stop the operation finger at the target position. It is considered that if the space of the target position is 10 mm, the distance of overshoot exceeds the 10 mm so as to fall out of the range of the target position, but it was confirmed that if the space of the target position is 20 mm, the distance of overshoot falls within the range of the target position, thus it becomes possible to stably stop the operation finger at the target position.

From the above-mentioned result, the distance of overshoot setting part 14 is configured to calculate the distance of overshoot based on the relational expression between the speed of the operation finger and the distance of overshoot so as to output as the distance of overshoot information S₄. The relational expression is included in the setting, information 140. Further, as one example of the relational expression, the above-mentioned expression of the regression lines (y=0.11x) can be used, but not particularly limited to this, an expression in accordance with the shape and width of the target position may be used. In this case, the distance of overshoot setting part 14 is configured to set the distance of overshoot based on the detection point information S₁, the target position information S₃ and the setting information 140.

In addition, the distance of overshoot setting part 14 is configured to, for example, calculate the speed of the operation finger based on at least two detection points detected in a continuous cycle.

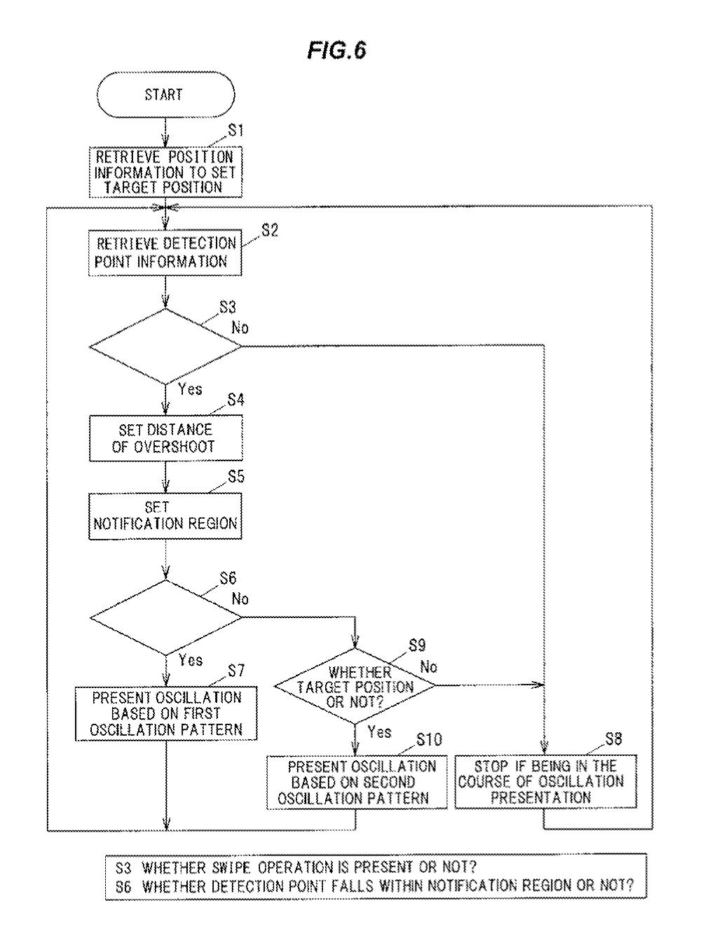

Hereinafter, an operation of the operation device 1 will be explained dependent on the flowchart shown in FIG. 6.

(Operation)

When the power source of the vehicle 4 is supplied, the touch sensor 10 of the operation device 1 periodically outputs the detection point information S₁ to the control part 22, and simultaneously the target position setting part 12 retrieves the position information S₂ from the operated object so as to set the target position and generates the target position information S₃ so as to output to the control part 22 (S1)

When the control part 22 periodically retrieves the detection point information S₁ (S2), the control part 22 decides whether a swipe operation has been carried out or not. When the control part 22 decides that the swipe operation has been carried out (S3: Yes), the control part 22 outputs the detection point information S₁ to the distance of overshoot setting part 14, and simultaneously generates the operation information S₇ so as to output. Further, the order of Step 1 and Step 2 may be reversed. In addition, if the control part 22 detects a touch operation instead of the swipe operation, the control part 22 generates the operation information S₇ based on the touch position so as to output.

The distance of overshoot setting part 14 sets the distance of overshoot based on the detection point information S₁ retrieved and generates the distance of overshoot information S₄ (S4), so as to output to the control part 22.

The control part 22 outputs the target position information S₃ and the distance of overshoot information S₄ retrieved to the notification region setting part 16. The notification region setting part 16 sets the notification region based on the target position information S₃ and the distance of overshoot information S₄ retrieved and generates the notification region information S₅ so as to output (S5).

The control part 22 decides whether the detection point has reached within the notification region based on the detection point information S₁ and the notification region information S₅ or not. When the detection point has reached within the notification region (S6: Yes), the control part 22 outputs the control signal S₆ for presenting the first oscillation pattern 181 to the oscillation presentation part 18. The oscillation presentation part 18 presents the oscillation based on the first oscillation pattern 181 based on the control signal S₆ and the oscillation pattern information 180 (S7).

Here, in Step 3, when the control part 22 decides that the swipe operation has not been detected (S3: No), if being in the course of oscillation presentation, the control part 22 stops the control signal S₆ so as to stop the oscillation (S8). If not being in the course of oscillation presentation, the control part 22 proceeds the processing to Step 2.

In addition, in Step 6, when the control part 22 decides that the detection point does not fall within the notification region (S6: No), the control part 22 decides that the detection point has reached the target position or not. If the detection point has reached the target position (S9: Yes), the control part 22 outputs the control signal S₆ for presenting the second oscillation pattern 182 to the oscillation presentation part 18. The oscillation presentation part 18 presents the oscillation based on the second oscillation pattern 182 based on the control signal S₆ and the oscillation pattern information 180 (S10).

In addition, in Step 9, if the detection point has not reached the target position (S9: No), if not being in the course of oscillation presentation, the control part 22 proceeds the processing to Step 2.

The operation device 1 carries out the above-mentioned series of operation, for example, until the power source of the vehicle 4 is interrupted.

### Advantageous Effect of Embodiment

The operation device 1 according to the embodiment is capable of notifying to prevent the operation of overshoot that the operation finger passes through the target position. In particular, the operation device 1 is configured such that the distance of overshoot setting part 14 sets the distance of overshoot, and the notification region setting part 16 sets the notification region 107 based on the distance of overshoot set. Consequently, in comparison with a case that the notification region based on the distance of overshoot is not set, even if the operation finger is moved until the operator becomes aware of the notification so as to stop the operation, it becomes possible to stop the operation finger at the target position, thus the operation device 1 is capable of notifying to prevent the operation of overshoot that the operation finger passes through the target position.

The operation device 1 is configured such that the distance of overshoot setting part 14 sets the distance of overshoot in accordance with the speed of the detection point, in other words, the speed of the operation, thus the operation device 1 is capable of appropriately setting the distance of overshoot, in comparison with a case that the distance of overshoot in accordance with the speed is not set.

The operation device 1 is configured to present oscillations based on oscillation patterns different from each other in the notification region 107 and the target position 106. Consequently, in comparison with a case that oscillations based on oscillation patterns different from each other are not presented, the operator can recognize that the target position exists near, by receiving stimulation due to the first oscillation pattern 181 before reaching the target position, and further the operator can easily recognize the fact of having reached the target position by stimulation due to the second oscillation pattern 182 different from the first oscillation pattern 181, thus the operation of overshoot can be prevented.

The operation device 1 is configured to present oscillations based on oscillation patterns different from each other in the notification region 107 and the target position 106, thus the operation device 1 can prevent an operation by the operator while looking at the operation surface 100 so as to prevent a visual axis movement of the operator.

Further, as a modification, the notification part is not particularly limited to one configured to carry out a notification by presenting an oscillation, but may be configured to carry out a notification including at least sound and light, in addition to the oscillation.

The operation device 1 according to the above-mentioned embodiment and modification may be configured such that a part thereof is achieved by, for example, a program that computers execute, an ASIC (Application Specific Integrated Circuit), a FPGA (Field Programmable Gate Array) or the like, in accordance with the use.

Further, the ASIC is an integrated circuit for specific application, and the FPGA is a programmable LSI (Large Scale Integration).

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An operation device, comprising:
a detection part configured to detect an operation applied to an operation surface so as to calculate a detection point on the operation surface;
a target position setting part configured to set a target position on the operation surface based on information retrieved from an operated object;
a distance of overshoot setting part configured to set a distance of overshoot based on the target position set, the distance of overshoot being predicted a distance to be overshot by the detection point from the target position while the detection point moves;
a notification region setting part configured to set a notification region configured to perform notification based on the target position and the distance of overshoot; and
a notification part configured to notify that the detection point has reached the notification region.

2. The operation device according to claim 1, wherein the distance of overshoot setting part is configured to set the distance of overshoot based on the speed of the detection point.

3. The operation device according to claim 1, wherein the notification part is configured to perform a first notification when the detection point is detected in the notification region, and to perform a second notification different from the first notification when the detection point is detected in the target position.

4. The operation device according to claim 1, wherein the operation applied to the operation surface comprises a swipe operation to let the detection point move.

5. The operation device according to claim 1, wherein the operation device is electromagnetically connected to a display device to display a functional situation of an electronic device as an operated object so as to remotely operate the electronic device via the display device.

6. The operation device according to claim 1, wherein the target position ranges inside a circle with a predetermined radius (r1), and
the notification region comprises a region that ranges inside a circle with a radius (r1+d1) and outside the target position, wherein d1 represents the distance of overshoot.
